(19) United States
(12) Patent Application Publication
(10) Pub. No.: US 2015/0100338 A1
(43) Pub. Date: Apr. 9, 2015

(54) METHODS FOR REQUESTING AND CHECKING RESULTS OF DIAGNOSTIC TESTS FOR AVELLINO CORNEAL DYSTROPHY

(71) Applicant: Avellino Co., Ltd, Gangnam-gu (KR)

(72) Inventors: Gene Lee, Gyeonggi-do (KR); Jung Kuk Yun, Chungcheongbuk-do (KR)

(21) Appl. No.: 14/472,325

(22) Filed: Aug. 28, 2014

Related U.S. Application Data
(63) Continuation-in-part of application No. PCT/KR2013/001652, filed on Feb. 28, 2013.

(30) Foreign Application Priority Data
Feb. 28, 2012 (KR) 10-2012-0020514

(51) Int. Cl. G06F 19/00

(52) U.S. Cl. CPC G06F 19/3418
USPC 705/2

(57) ABSTRACT

A portable electronic device with a touch-sensitive display launches a software application configured for requesting a diagnostic test for Avellino corneal dystrophy and checking a result of the diagnostic test for Avellino corneal dystrophy. The device logs in to the software application. Subsequent to logging into the software application, the device displays a request form for a diagnostic test for Avellino corneal dystrophy on the touch-sensitive display. While displaying the request form, the device receives a signature at a location on the touch-sensitive display that corresponds to a signature block of the displayed request form. In response to receiving the signature, the device stores the signature for the request form as an electronic file in the memory. The device transmits the signed request form to a server computer that is located remotely from the portable electronic device.

### RELATED APPLICATION

This application is a continuation-in-part of International Application PCT/KR2013/001652, filed Feb. 28, 2013, which claims priority to Korean Patent Application Serial No. 10-2012-0020514, filed Feb. 28, 2012, both of which are incorporated by reference herein in their entirety.

### TECHNICAL FIELD

This application is related to methods of requesting diagnostic tests for Avellino corneal dystrophy and checking results of the diagnostic tests, and in particular, methods of requesting diagnostic tests for Avellino corneal dystrophy and checking results of the diagnostic tests using portable electronic devices, such as smart phones and tablet computers.

### BACKGROUND

Corneal dystrophy is an autosomal dominant hereditary disease, which begins with a blurry symptom in the center of cornea and gradually spreads and thus ends up vision loss as a patient gets older. It includes Avellino corneal dystrophy, Granular corneal dystrophy, lattice type I corneal dystrophy, Reis-bucklers corneal dystrophy, etc., and is caused by mutation of a gene coding (3IG-H3 protein.

Heterozygous patients suffering from Avellino corneal dystrophy appear to have severe loss of vision as getting older and homozygous patients appear to have complete loss of vision since 6 years old. Avellino corneal dystrophy is a newly named disease in 1988, divided from generally called Granular corneal dystrophy because it was found to have discrete symptoms and genetic foundation. Also, it has been known to be the most common corneal dystrophy worldwide, 1/340 to 1/1000 of prevalence rate in Korea (the case of heterozygote) based on genetic analysis indicates that it is a common dystrophy (Holland, E. J. et al., Ophthalmology, 99:1564, 1992; Kennedy, S. M. et al., Br. J. Ophthalmol., 80:489, 1996; Dolmetsch, A. M. et al., Can. J. Ophthalmol., 31:29, 1996; Afshari, N. A. et al., Arch. Ophthalmol., 119:16, 2001; Stewart, H. S. Hum. Mutat., 14:126, 1999).

The present inventors has found that if a patient suffering from heterozygous Avellino corneal dystrophy has LASIK surgery, 2 years later, opacity of cornea starts to develop aggressively and eventually results in vision loss (Jun, R. M. et al., Opthalmology, 111:463, 2004). Previously, eye surgery has been performed with an expectation that LASIK or Excimer Laser surgery would get rid of vision blurriness of a patient suffering from corneal dystrophy. Also, even in Korea, approximately 3 hundred thousand cases of LASIK surgery have been performed, which leads to the assumption that 300 people lost their vision, based on 1/1000 of minimum estimation of heterozygous patients suffering from Avellino corneal dystrophy. Patients who have undergone LASIK surgery are mainly in their 20's and 30's carrying out productive activities; therefore, their vision loss causes serious troubles in both society and economics.

In addition, after approval of LASIK surgery in year 2000 in USA, African American patients suffering from Avellino corneal dystrophy who underwent LASIK surgery have been found to lose eye sight, which infers that plenty of similar cases might be occurring throughout the world.

Therefore, although accurate diagnosis of Avellino corneal dystrophy is required to prevent the progression of Avellino corneal dystrophy by LASIK surgery, the diagnosis of Avellino corneal dystrophy is just conducted by microscopic observation of corneal opacity and thus often doctors miss latent symptoms of patients to perform LASIK surgery, which results in vision loss. Therefore, rapid and precise diagnosis of corneal dystrophy is desperately in need.

There are currently two ways to request the diagnosis of Avellino corneal dystrophy: (1) to directly sign on a request form, which is the common option used, and (2) to sign on an auxiliary signature input device after reading a request form displayed on a monitor connected to a computer.

The first method, however, requires the request forms or diagnosis results be sent and received in an analog way by mail, or be scanned into an electronic file and then transmitted. This process is time-consuming and cumbersome. The second method requires an auxiliary apparatus for receiving a signature input, cost of which imposes an economic burden, and the method has spatial limitations because users can only request the diagnostic test on a computer that is connected to such auxiliary apparatus.

The present inventors made efforts to address these problems, and, as a result, verified that users can easily request diagnostic tests for Avellino corneal dystrophy and check test results anytime, and anywhere, by running a software application, configured for requesting diagnostic tests for Avellino corneal dystrophy and checking test results, on a mobile electronic device, logging in and directly signing on a consent form, for a diagnostic test for Avellino corneal dystrophy, displayed on a user interface of the mobile electronic device, without the need for additionally using mail services or an auxiliary signature input apparatus.

### SUMMARY

The application describes systems and methods for requesting diagnostic tests for Avellino corneal dystrophy as well as systems and methods for checking test results, using mobile electronic devices.

In accordance with some embodiments, methods for requesting diagnostic tests include executing a software application (e.g., Avellino application) that is configured for allowing a user to request a diagnostic test for Avellino corneal dystrophy and also check a test result on a mobile electronic device. Materials related to Avellino corneal dystrophy are provided. The user logs on to the software application. The user signs on a consent form displayed on the mobile electronic device in connection with Avellino corneal dystrophy diagnostic tests, which are saved in the form of an electronic file. The said signed consent form is transmitted to a web server, along with an electronic request form created at the time of request.

In accordance with some embodiments, methods for checking test results include executing a software application (e.g., Avellino application) that is configured for allowing a user to check results of a diagnostic test for Avellino corneal dystrophy on a mobile electronic device. The user logs on to the software application, and the test result is transmitted from the web server and displayed on the display of the mobile device.

In accordance with some embodiments, a method is performed at a portable electronic device that includes one or more processors, memory, and a touch-sensitive display. The method includes launching a software application configured for requesting a diagnostic test for Avellino corneal dystrophy and checking a result of the diagnostic test for Avellino corneal dystrophy; logging in to the software application; subsequent to logging into the software application, displaying a request form for a diagnostic test for Avellino corneal dystrophy on the touch-sensitive display; while displaying the request form for the diagnostic test for Avellino corneal dystrophy on the touch-sensitive display, receiving a signature at a location on the touch-sensitive display that corresponds to a signature block of the displayed request form; in response to receiving the signature, storing the signature for the request form as an electronic file in the memory; and transmitting the signed request form for the diagnostic test for Avellino corneal dystrophy to a server computer that is located remotely from the portable electronic device.

In accordance with some embodiments, a portable electronic device includes a touch-sensitive display, one or more processors, and memory. The memory stores one or more programs for execution by the one or more processors. The one or more programs, when executed by the one or more processors, cause the portable electronic device to perform a method. The method includes launching a software application configured for requesting a diagnostic test for Avellino corneal dystrophy and checking a result of the diagnostic test for Avellino corneal dystrophy; logging in to the software application; subsequent to logging into the software application, displaying a request form for a diagnostic test for Avellino corneal dystrophy on the touch-sensitive display; while displaying the request form for the diagnostic test for Avellino corneal dystrophy on the touch-sensitive display, receiving a signature at a location on the touch-sensitive display that corresponds to a signature block of the displayed request form; in response to receiving the signature, storing the signature for the request form as an electronic file in the memory; and transmitting the signed request form for the diagnostic test for Avellino corneal dystrophy to a server computer that is located remotely from the portable electronic device.

In accordance with some embodiments, a non-transitory computer readable storage medium includes one or more programs for execution by a portable electronic device with a touch-sensitive display. The one or more programs, when executed by the portable electronic device, cause the portable electronic device to perform a method. The method includes launching a software application configured for requesting a diagnostic test for Avellino corneal dystrophy and checking a result of the diagnostic test for Avellino corneal dystrophy; logging in to the software application; subsequent to logging into the software application, displaying a request form for a diagnostic test for Avellino corneal dystrophy on the touch-sensitive display; while displaying the request form for the diagnostic test for Avellino corneal dystrophy on the touch-sensitive display, receiving a signature at a location on the touch-sensitive display that corresponds to a signature block of the displayed request form; in response to receiving the signature, storing the signature for the request form as an electronic file in the memory; and transmitting the signed request form for the diagnostic test for Avellino corneal dystrophy to a server computer that is located remotely from the portable electronic device.

### BRIEF DESCRIPTION OF THE DRAWINGS

FIG. 1 shows a user interface of a software application running on a tablet computer in accordance with some embodiments.

FIG. 2 shows a user interface of the software application, that provides materials related to Avellino corneal dystrophy in accordance with some embodiments.

FIG. 3 shows a login user interface of the software application in accordance with some embodiments.

FIG. 4 shows a user interface of the software application that displays a request form for a diagnostic test for Avellino corneal dystrophy in accordance with some embodiments.

FIG. 5 shows a user interface of the software application for transmitting a signed request form in accordance with some embodiments.

FIG. 6 shows a user interface of the software application that displays results of a diagnostic test in accordance with some embodiments.

FIG. 7 shows an introduction user interface and a main user interface that appear when a software application is launched in accordance with some embodiments.

FIG. 8 shows a user interface of a software application that provides materials related to Avellino corneal dystrophy in accordance with some embodiments.

FIG. 9 shows a login user interface of the software application in accordance with some embodiments.

FIG. 10 shows a user interface of a software application that displays a request form for a diagnostic test for Avellino corneal dystrophy in accordance with some embodiments.

FIG. 11 shows a user interface of a software application for transmitting a request form for a diagnostic test for Avellino corneal dystrophy in accordance with some embodiments.

FIG. 12 shows a user interface of a software application that displays the results of a diagnostic test in accordance with some embodiments.

FIG. 13 is a flow chart that describes methods for requesting a diagnostic test for Avellino corneal dystrophy and checking results of such test in accordance with some embodiments.

FIG. 14 is a block diagram illustrating an exemplary network architecture in accordance with some embodiments.

FIG. 15 is a block diagram illustrating an exemplary portable electronic device in accordance with some embodiments.

FIGS. 16A-16B are flow diagrams illustrating a method of requesting a diagnostic test for Avellino corneal dystrophy in accordance with some embodiments.

### DETAILED DESCRIPTION

“Avellino application” described in this application is a software application program that is configured for running on a smart phone or a tablet computer, with which a user can request a diagnostic test for Avellino corneal dystrophy and check results of such test.

Detailed operating principles of the software application are described below.

Upon touching the introduction user interface, users are connected to the sub main page and can confirm the number of diagnostic tests of Avellino corneal dystrophy that were conducted by Avellino Laboratory Inc. as well as the number of cases in which genetic mutations were found in connection with Avellino corneal dystrophy.

Users can sign up or log in on the sub main page. Upon requesting to sign up, the testing institute applies either the administrator level that allows all tasks such as writing the consent form, managing the consent form, writing the request form, managing the request form, and confirming the diagnostic test results, or the sub-administrator level that only allows writing the consent form, and then approves the sign up. When logged on to the application upon approval, users can check the number of cases in which genetic mutations were found in connection with Avellino corneal dystrophy, among the diagnostic tests conducted at the applicable clinic.

Upon touching the registration of consent form, users can write the consent form and then register it by signing. The written consent form can be found in the consent form management category.

Upon touching the registration of request form, users can check the list of specimens in which requests can be made, among whose consent forms are completed. Using the check boxes of the list of specimens, users can select the specimens for the diagnostic test of Avellino corneal dystrophy. Upon touching the registration button, the applicable list is moved to the request form management page and the request for the diagnostic test to Avellino Laboratory Inc. is completed. Thereafter, users can view the list of specimens for which the diagnostic tests are requested on the request form management page. This list is removed after the tests are conducted and the results are transmitted. Upon touching the test results button, information about the most recent three specimens in which genetic mutations were found in connection with Avellino corneal dystrophy, among the specimens tested for Avellino corneal dystrophy at the applicable clinic, appears. Also, the results of all diagnostic tests conducted on specimens upon which such tests were requested can be checked.

Additionally, information about Avellino Laboratory Inc. is available upon touching the notice button. Materials such as research papers provided by Avellino Laboratory Inc. are available in the data center. The application can also be linked to Facebook and Twitter accounts.

In some embodiments, the software application is exclusively for iPads. In some embodiments, anyone can download the application for free from an application store.

Below describes some embodiments, along with figures attached.

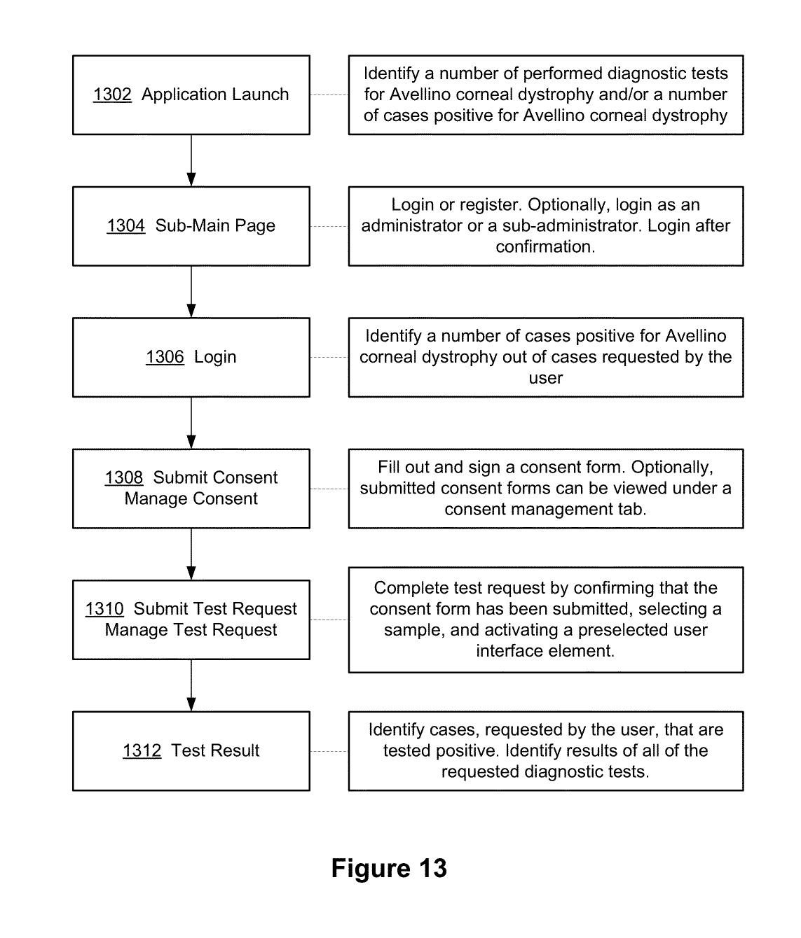

As shown in the flow chart in FIG. 13, some embodiments include methods for requesting the diagnostic test of Avellino corneal dystrophy. A software application, which allows users to request diagnostic tests for Avellino corneal dystrophy and also to check diagnosis test results, is run on a mobile electronic device. Materials related to Avellino corneal dystrophy are provided. The users log on to the software application. The users sign on consent forms displayed on mobile electronic devices in connection with Avellino corneal dystrophy diagnostic tests, which are saved in an electronic form. The said signed consent forms are transmitted to a web server.

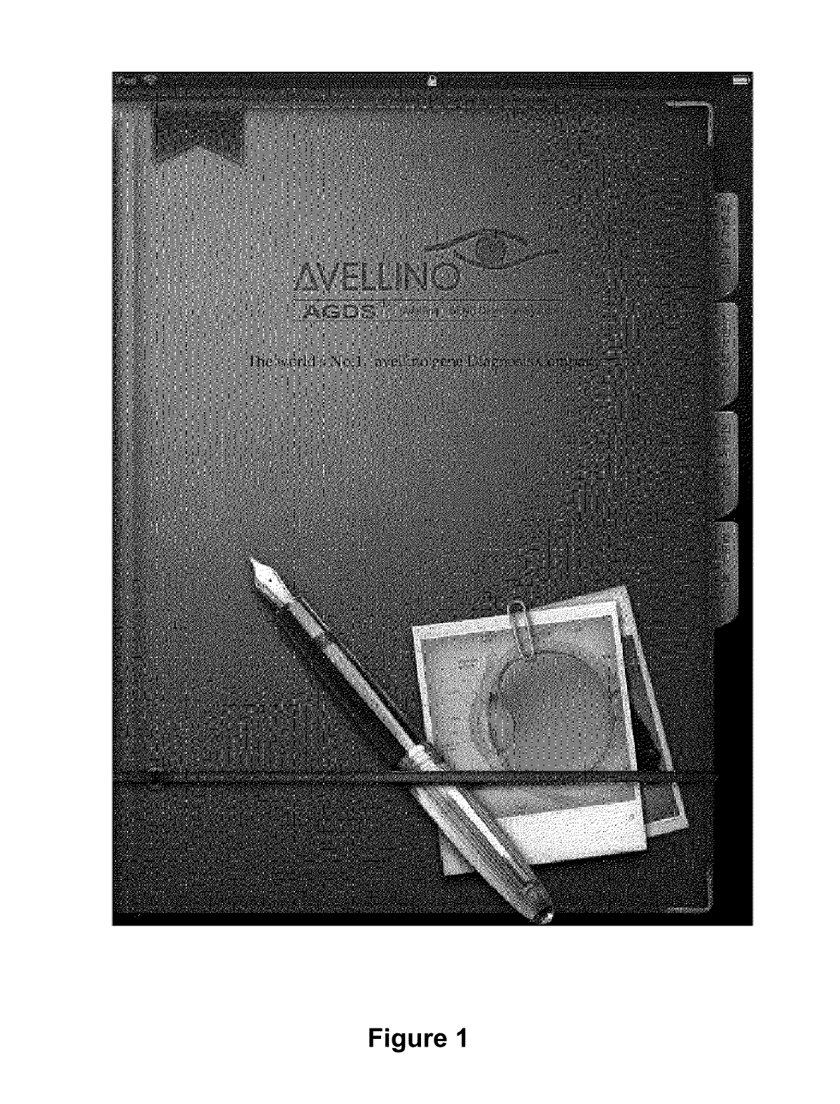

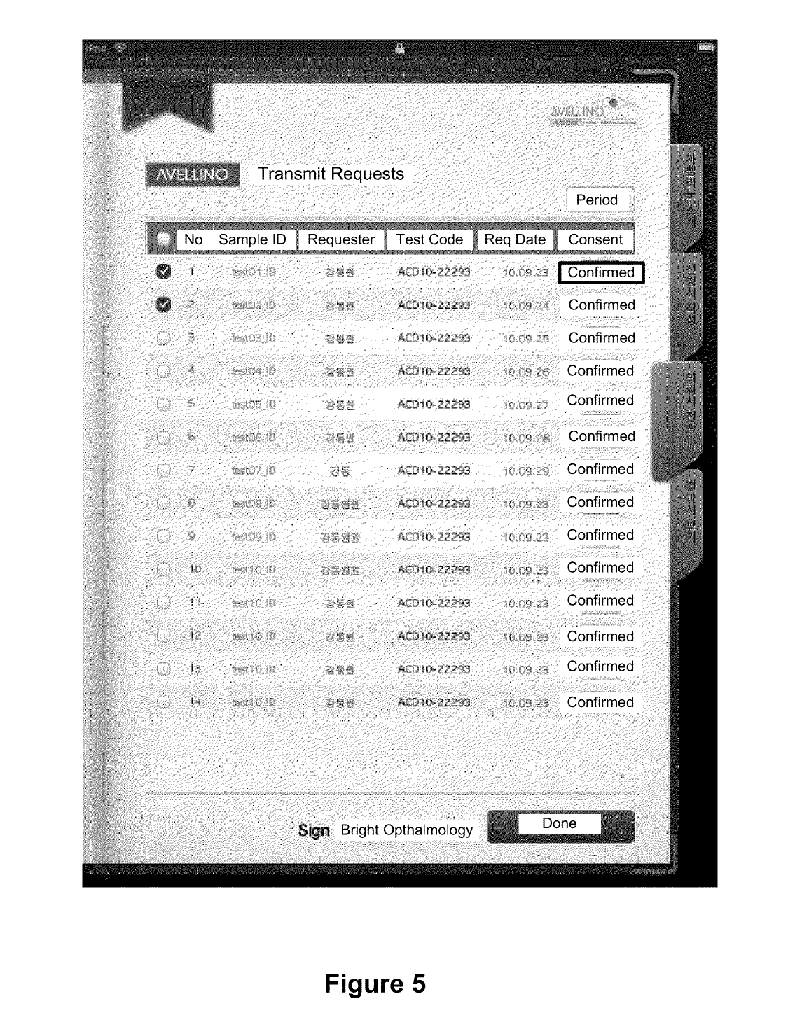

FIGS. 1 through 6 show user interfaces according to some embodiments.

FIG. 1 shows a user interface of a software application running on a tablet computer in accordance with some embodiments.

As shown in FIG. 1, users can see the introduction of Avellino Lab, write the consent form, transmit the request form, and check the diagnosis upon running a software application on mobile electronic devices such as smart phones or tablet computers.

More specifically, by touching the introduction button on the main user interface of the software application, users are provided with materials related to Avellino corneal dystrophy. By touching the consent form writing tab, users can log in and sign the request form for the diagnostic test of Avellino corneal dystrophy. By touching the send tab, users can send the signed request form to the web server. By touching the results tab, users can receive the results of the diagnostic test and confirm the diagnosis.

Among the said four functions of the Avellinio application, writing consent form, sending request form, and checking the results of the diagnostic test are available only after logging in.

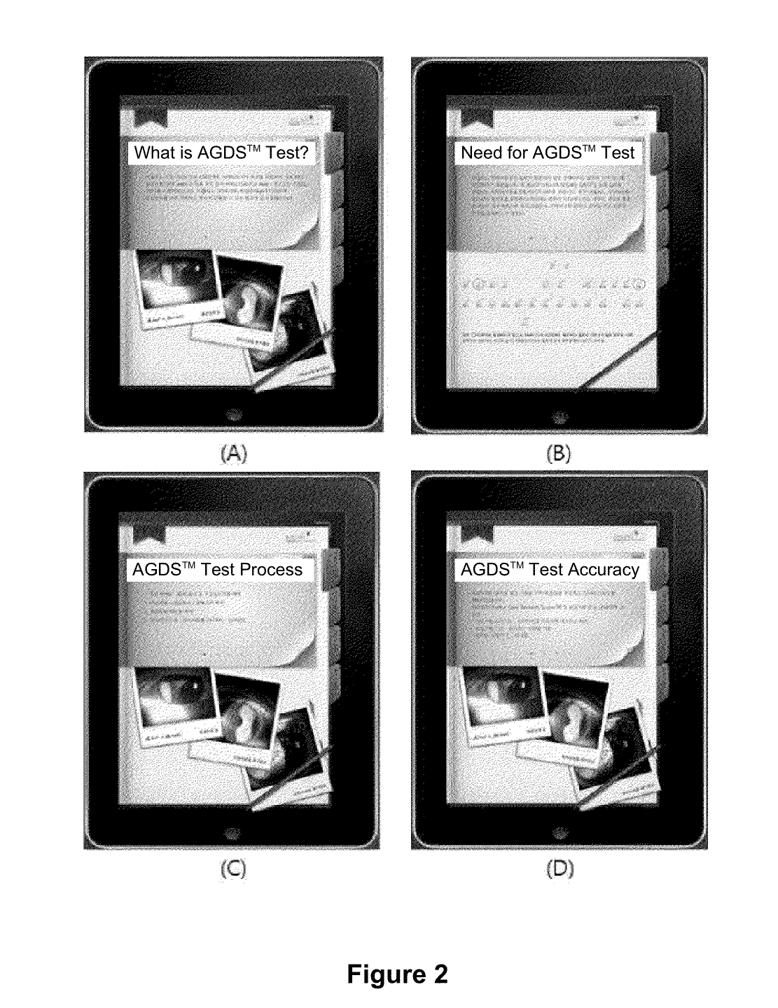

FIG. 2 shows a user interface of the software application, that provides materials related to Avellino corneal dystrophy in accordance with some embodiments.

Upon touching the Avellino introduction tab on the main user interface of the software application, users have access to information such as (A) definition of AGDS (Avellino Gene Detection System) test, (B) necessity of the diagnostic test, (C) test process, and (D) accuracy of the test.

Upon touching the consent form writing tab on the main user interface of the software application, the log-in page appears. To log in, users must go through the process of registering their ID and password. After installing the software application, users can freely log in upon going through the said registration process.

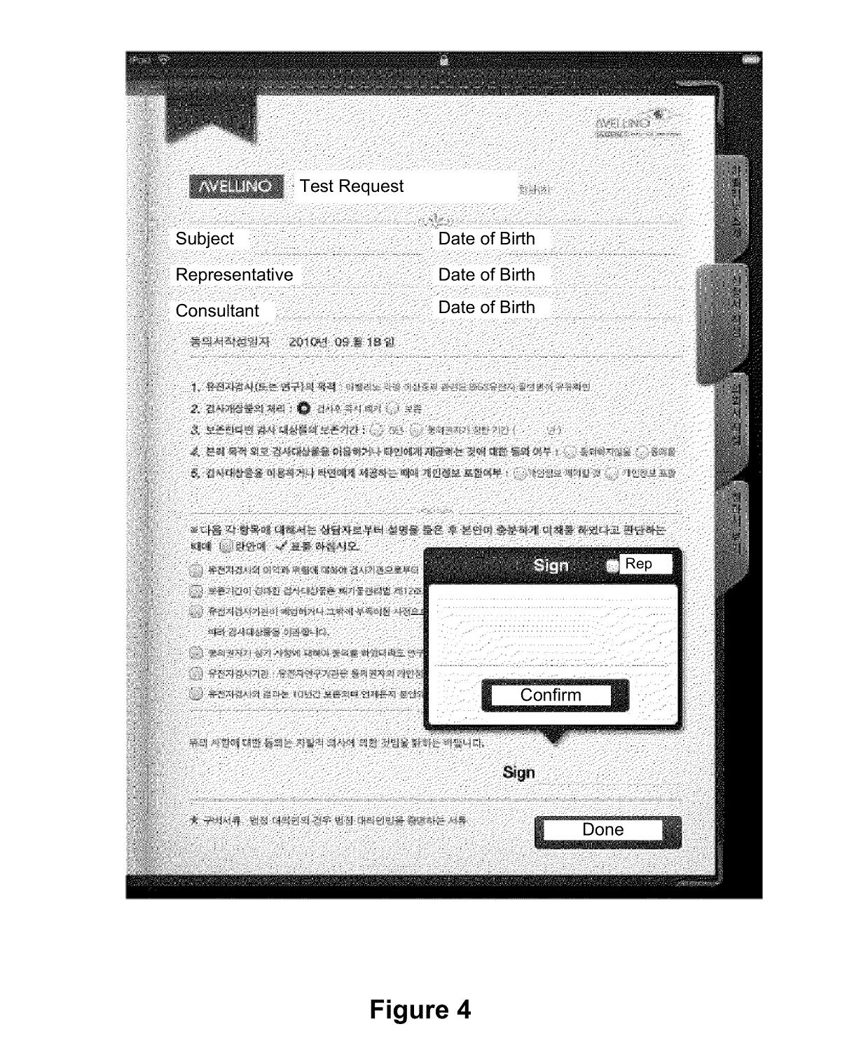

When users successfully log on by entering their registered ID and password, the request form user interface (consent form for genetic test) appears as in FIG. 4. The form contains the disposal method of subject specimens, the storage period for subject specimens that are stored, the option to allow the company to use the specimens for a purpose other than that originally intended or to provide the specimens to others, and the option to include personal information when the specimens are used or provided to others.

On the bottom of the request form, there is a signature box. Upon touching the signature box, a user interface for inputting the signature appears. By signing the signature input user interface, the signature box is filled.

The signed request form is saved as an electronic file. Once saved as an electronic file, it is either in read-only document form so that it can be read or copied but cannot be edited or corrected, or encrypted so that it cannot be edited or corrected. The said encryption automatically generates a randomized password, which prevents arbitrary edits or corrections of the document.

Upon touching the send tab on the main user interface of the software application, the user interface in which users can send the request form appears. The said user interface shows information including the sample ID, applicant, test code, and registration date. Users can also view the written consent form. Upon touching the “Finish” button on the user interface, the signed request form for the diagnostic test of Avellino corneal dystrophy is sent to the web server.

Items already sent no longer appear on the user interface. If a request form for the diagnostic test of Avellino corneal dystrophy is missing, a text box that reads “there is no registered request form for the diagnostic test of Avellino corneal dystrophy” appears.

Some embodiments include methods for checking diagnosis results. The software application, which allows the users to request the diagnostic test of Avellino corneal dystrophy and also to confirm the diagnosis, is run on a mobile electronic device. The users log on to the software application. The diagnosis is transmitted from the web server and displayed on the monitor of the mobile device.

When the signed request form for the diagnostic test of Avellino corneal dystrophy is sent to the web server, the testing institute for Avellino corneal dystrophy extracts DNA from specimens of the applicant (blood samples, hair root samples, and mouth swabs, etc.), conducts genetic tests using the DNA, and then uploads the results of the tests on the said web server. The said specimens (blood samples, hair root samples, and mouth swabs, etc.) can be collected at the clinic after the request form for the diagnostic test of Avellino corneal dystrophy is sent. These specimens can then be sent to the said testing institute.

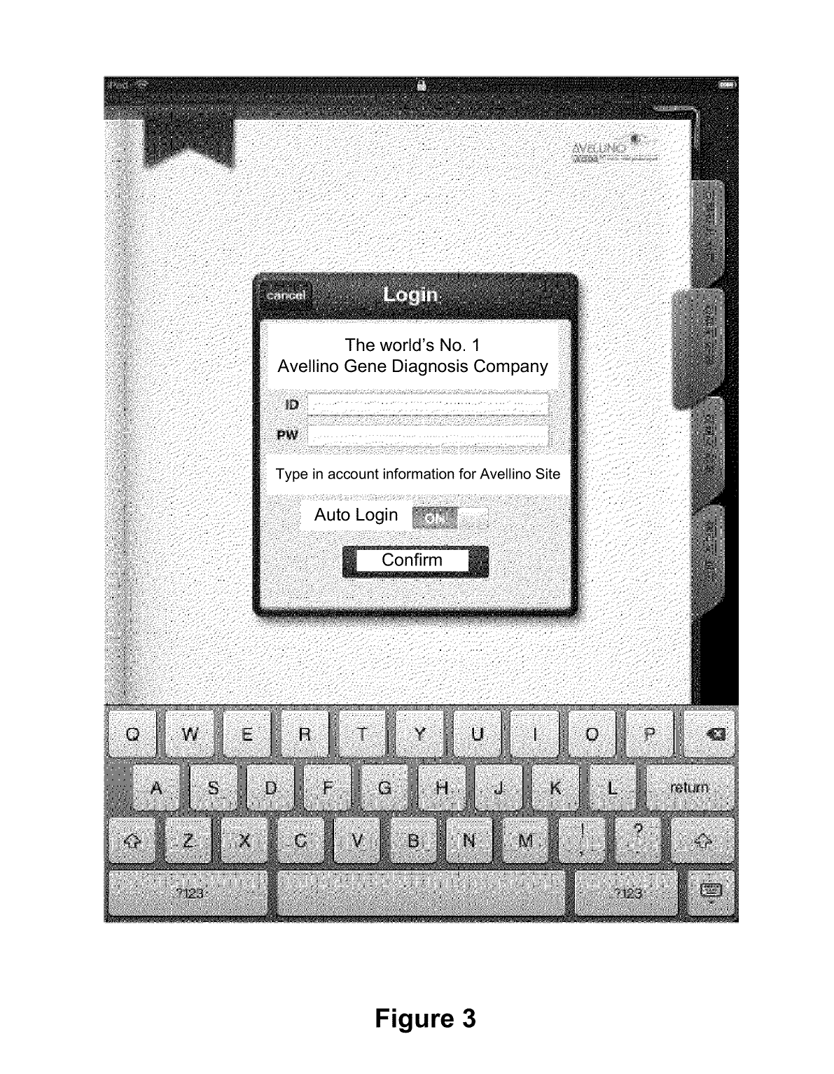

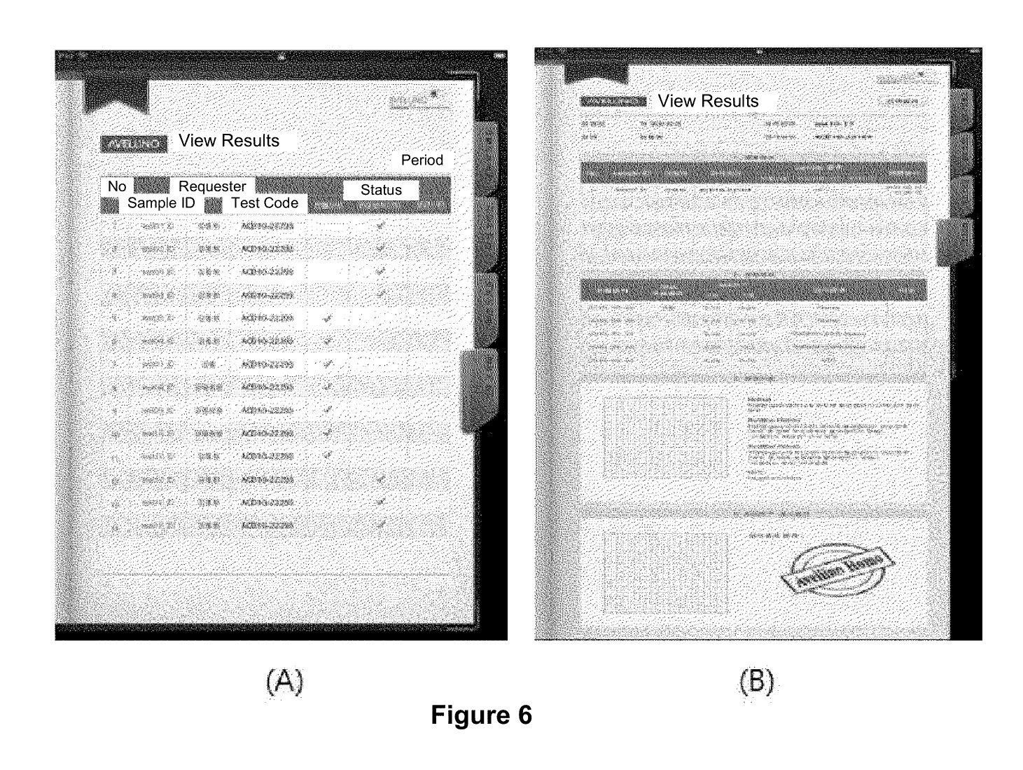

In order to confirm the results of the diagnostic test of Avellino corneal dystrophy, users must first request the diagnosis of Avellino corneal dystrophy and then run the “Avellino application” on a mobile electronic device. Then, upon touching the results tab on the main user interface of the software application, a login user interface appears as shown in FIG. 3. To log in, ID and password must be first registered. After installing the software application, users can freely log in upon completing the said registration process. Upon successfully logging in using the registered ID and password, the results of the diagnostic test of Avellino corneal dystrophy is transmitted from the web server. Users can also view information as shown in (A) of FIG. 6 in which the list of results of the diagnostic tests of Avellino corneal dystrophy appears, and upon selecting specific samples in the list, detailed information as shown in (B) in which sample information, test information, diagnosis standards, and test results appear.

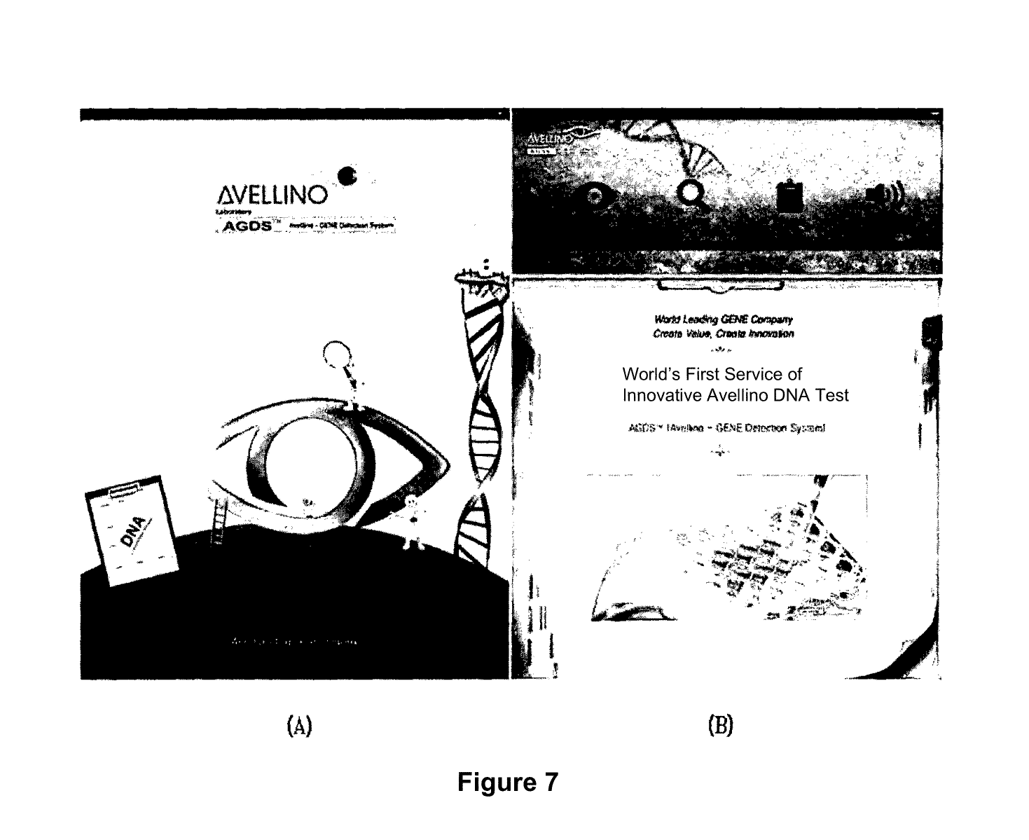

FIGS. 7 through 12 show user interfaces in accordance with some embodiments.

FIG. 7 shows (A) an introduction user interface and (B) a main user interface that appear when a software application is launched in accordance with some embodiments.

As shown in (B) of FIG. 7, users can request the diagnostic test of Avellino corneal dystrophy and check the results of such test by opening the software application.

In other words, by touching the Avellino corneal dystrophy tab on the main user interface of the software application, users have access to materials related to Avellino corneal dystrophy. By touching the request tab and the consent registration tab in the sub menu, users can sign on the consent form for the request for the diagnostic test of Avellino corneal dystrophy upon logging in and also send the signed consent form to the web server through the request registration tab. In addition, users can confirm the results of the diagnostic test received from the web server by touching the results tab.

Among the said four functions of the software application, requesting for the diagnostic test, checking the results of the test, notices related to the testing institute that are available in the sub menu of notices, and data center are available only after logging in.

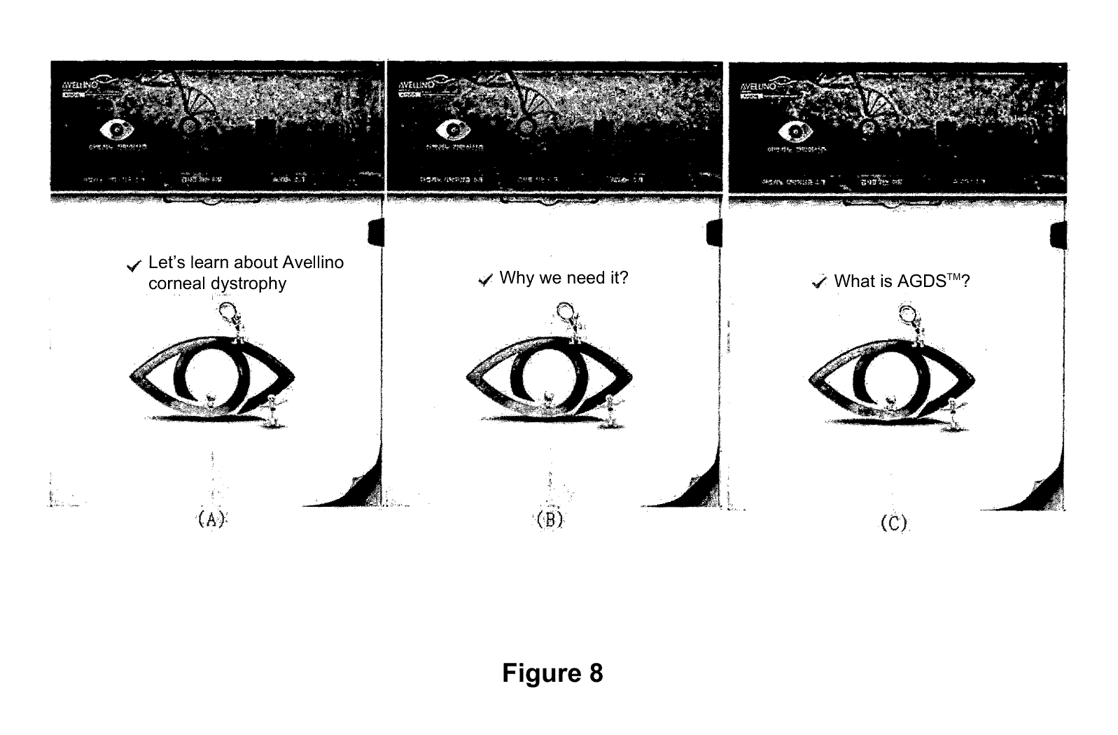

FIG. 8 shows a user interface of a software application that provides materials related to Avellino corneal dystrophy in accordance with some embodiments.

By touching the Avellino corneal dystrophy tab on the main user interface of the software application, materials such as (A) introduction of Avellino corneal dystrophy, (B) reasons for conducting a diagnostic test, and (C) introduction of AGDS™ are provided.

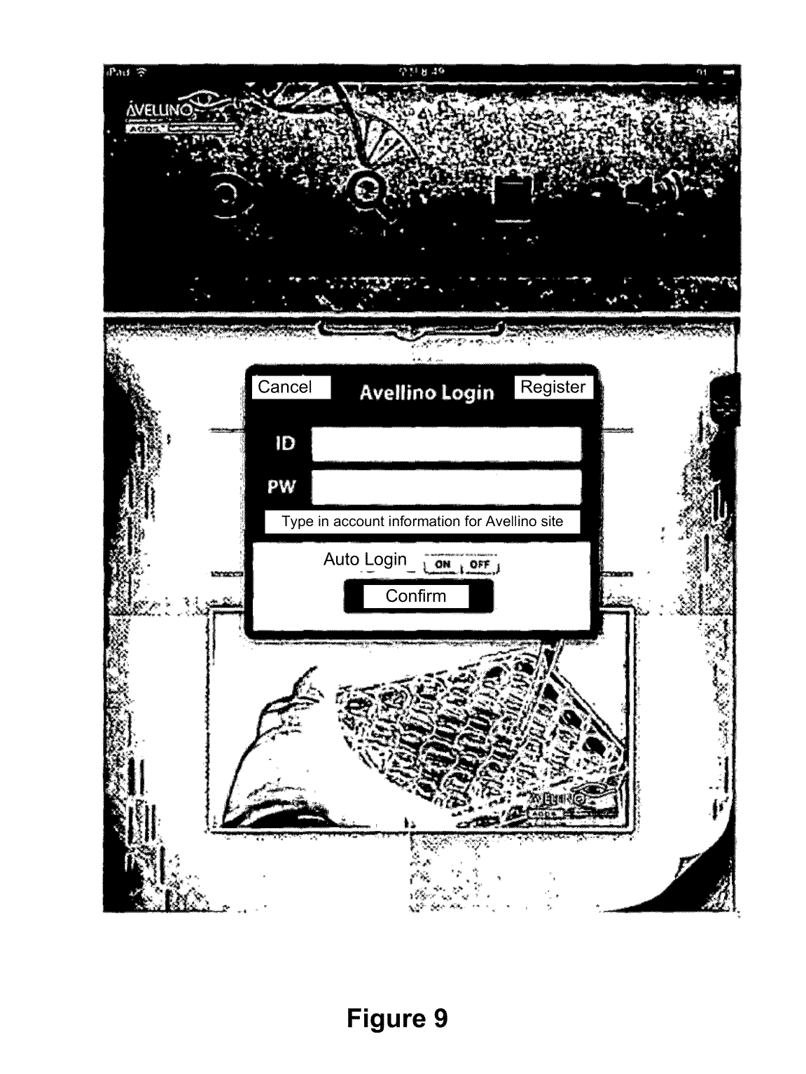

By touching the request tab on the main user interface of the software application, a login user interface appears as shown in FIG. 9. To log in, ID and password must be first registered. After installing the software application, users can freely log in upon completing the said registration process.

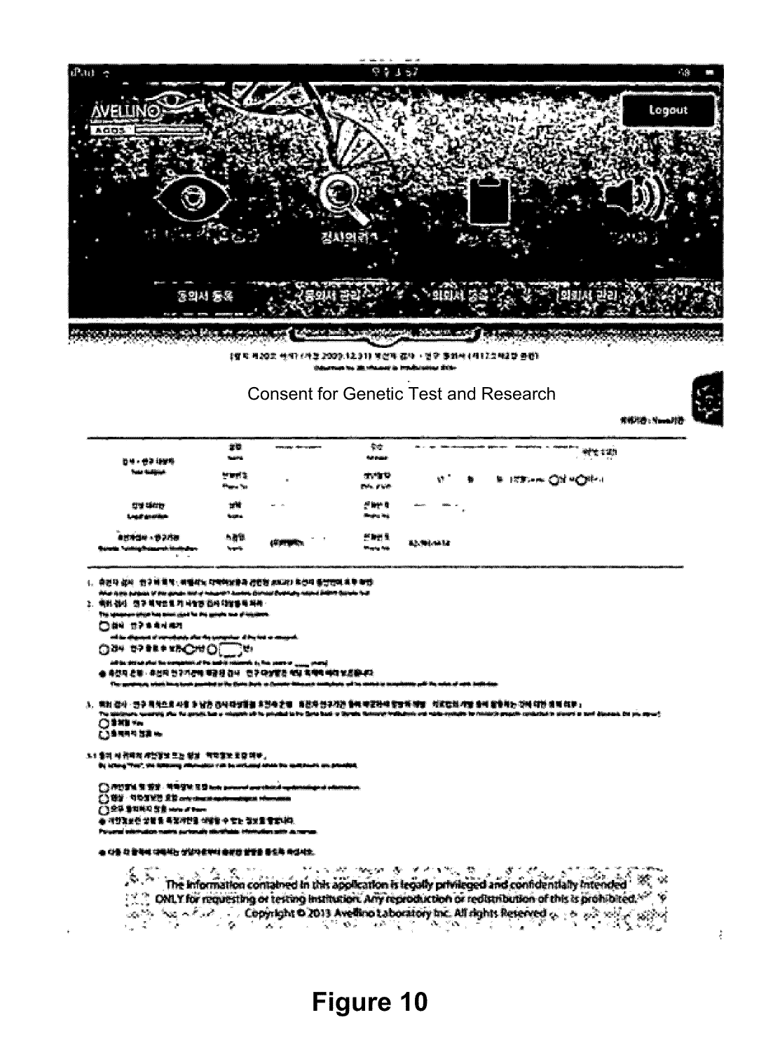

When users successfully log in to the application by entering their registered ID and password, the consent form user interface appears as in FIG. 10. The form contains the disposal method of subject specimens, the storage period for subject specimens that are stored, the option to allow the company to use the specimens for a purpose other than that originally intended or to provide the specimens to others, and the option to include personal information when the specimens are used or provided to others.

On the bottom of the request form, there is a signature box. Upon touching the signature box, a user interface for inputting the signature appears. By signing the signature input user interface, the signature box is filled.

The signed request form is saved as an electronic file. Once saved as an electronic file, it is either in read-only document form so that it can be read or copied but cannot be edited or corrected, or encrypted so that it cannot be edited or correct. The said encryption automatically generates a randomized password, which prevents arbitrary edits or corrections of the document.

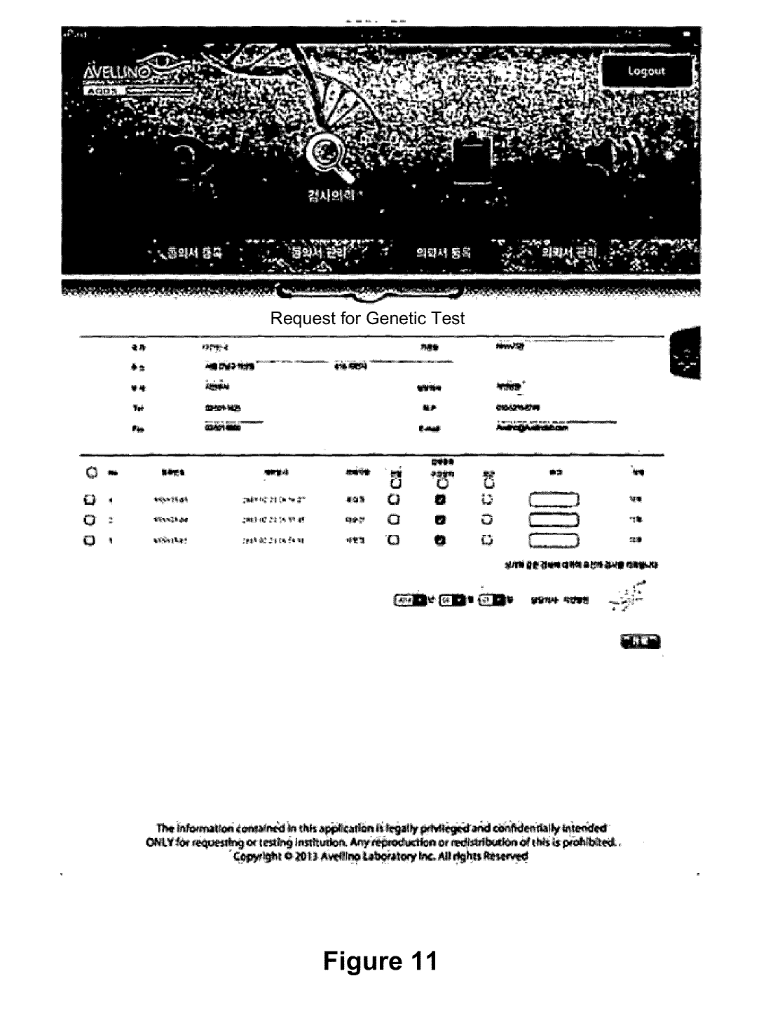

Upon touching the test request tab on the main user interface, and then touching the consent management tab in the sub menu, users can confirm the written consent form. In addition, upon touching the consent registration tab, the user interface in which users can check the content of the consent form and send the form appears as shown in FIG. 11. The registration user interface shows information such as the registration number and applicant information, etc. Upon touching the “register” button at the bottom of the user interface, the signed request form and consent form for the diagnostic test of Avellino corneal dystrophy are transmitted to the web server. By touching the request form management tab in which the list of request forms already sent appears, information such as the test code and registration date, etc. is available.

Items already sent at the registration menu no longer appear on the user interface. If a consent form for the diagnostic test of Avellino corneal dystrophy is missing, a text box that reads “there is no registered consent form for the genetic test” appears.

Some embodiments include methods for confirming diagnosis test results. The software application, which allows the users to request the diagnostic test of Avellino corneal dystrophy and also to confirm the diagnosis, is run on a mobile electronic device. The users log on to the software application. The diagnosis is transmitted from the web server and displayed on the monitor of the mobile device.

When the signed request form for the diagnostic test of Avellino corneal dystrophy is sent to the web server, the testing institute for Avellino corneal dystrophy extracts DNA from specimens of the applicant (blood samples, hair root samples, and mouth swabs, etc.), conducts genetic tests using the DNA, and uploads the results of the tests on the said web server. The said specimens (blood samples, hair root samples, and mouth swabs, etc.) can be collected at the clinic after the request form and consent form for the diagnostic test of Avellino corneal dystrophy are sent. These specimens can then be sent to the said testing institute.

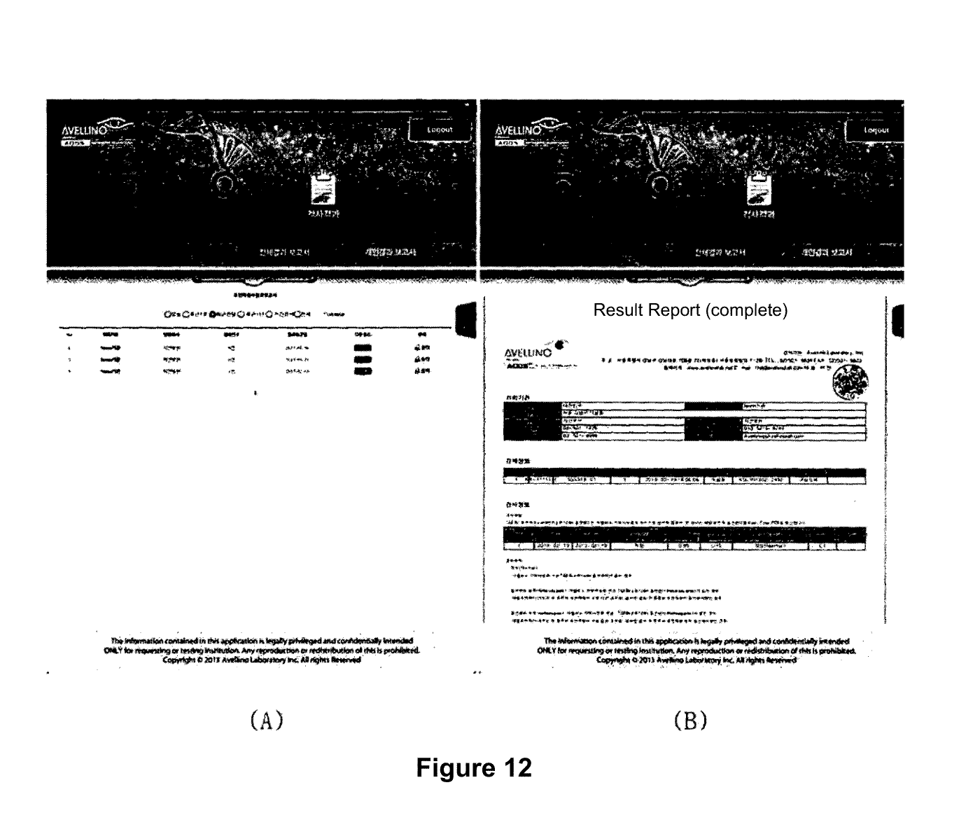

In order to confirm the results of the diagnostic test of Avellino corneal dystrophy, users must first request the diagnosis of Avellino corneal dystrophy and then run the “Avellino application” on a mobile electronic device. Then, upon touching the results tab on the main user interface of the software application, a login user interface appears as shown in FIG. 3. To log in, ID and password must be first registered. After installing the software application, users can freely log in upon completing the said registration process. Upon successfully logging in using the registered ID and password, the results of the diagnostic test of Avellino corneal dystrophy is transmitted from the web server. Users can also see information as shown in (A) of FIG. 12 in which the list of results of diagnostic tests of Avellino corneal dystrophy appears, and upon selecting specific samples in the list, detailed information as shown in (B) in which sample information, test information, diagnosis standards, and test results appear.

Some embodiments include a basic structure of a 3-tier system: client, middleware, and server. Applications are typically structured in a way that applications are placed at the middle-tier application server, and presentation logic and database are connected through middleware.

In some embodiments, XML service is applied to presentation logic so that the load at the client level is dispersed and performance is improved. In terms of processing transactions, middleware engages in where data duplication and flawlessness are checked and data verification is processed. Additionally, Xcode 4.2 was used as the development kit and PHP, objective C++, Mysql, or XML was used as the programming language. In some embodiments, the operating system is iOS 6.0.

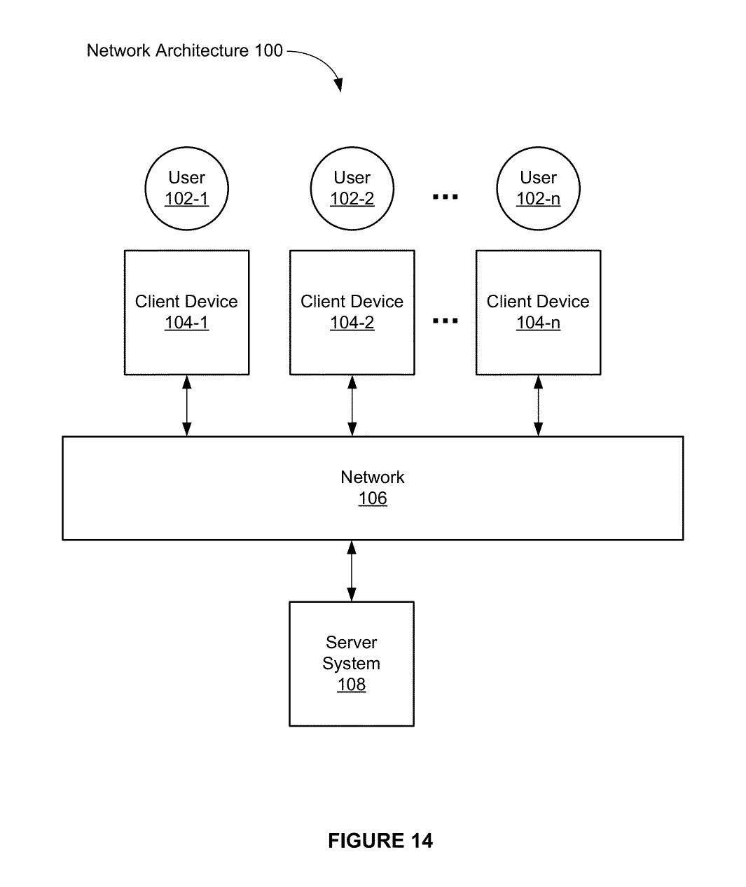

FIG. 14 is a block diagram illustrating an exemplary network architecture 100 in accordance with some embodiments. The network architecture 100 includes a number of client devices (also called “electronic devices,” “client systems,” “client computers,” or “clients”) 104-1, 104-2, . . . 104-n communicably connected to a server system 108 by one or more networks 106.

In some embodiments, the client devices 104-1, 104-2, . . . 104-n are computing devices such as smart watches, personal digital assistants, portable media players, smart phones, tablet computers, laptop computers, desktop computers, televisions with one or more processors embedded therein or coupled thereto, or other appropriate computing devices that can be used to communicate with the server system. In some embodiments, the server system 108 is a single computing device such as a computer server, while in other embodiments, the server system 108 is implemented by multiple computing devices working together to perform the actions of a server system (e.g., cloud computing). In some embodiments, the network 106 is a public communication network (e.g., the Internet or a cellular data network) or a private communications network (e.g., private LAN or leased lines) or a combination of such communication networks.

Users 102-1, 102-2, . . . 102-n employ the client devices 104-1, 104-2, . . . 104-n to access the server system 108. For example, one or more of the client devices 104-1, 104-2, . . . 104-n execute software applications that are specific to the server system (e.g., “apps” running on smart phones or tablets).

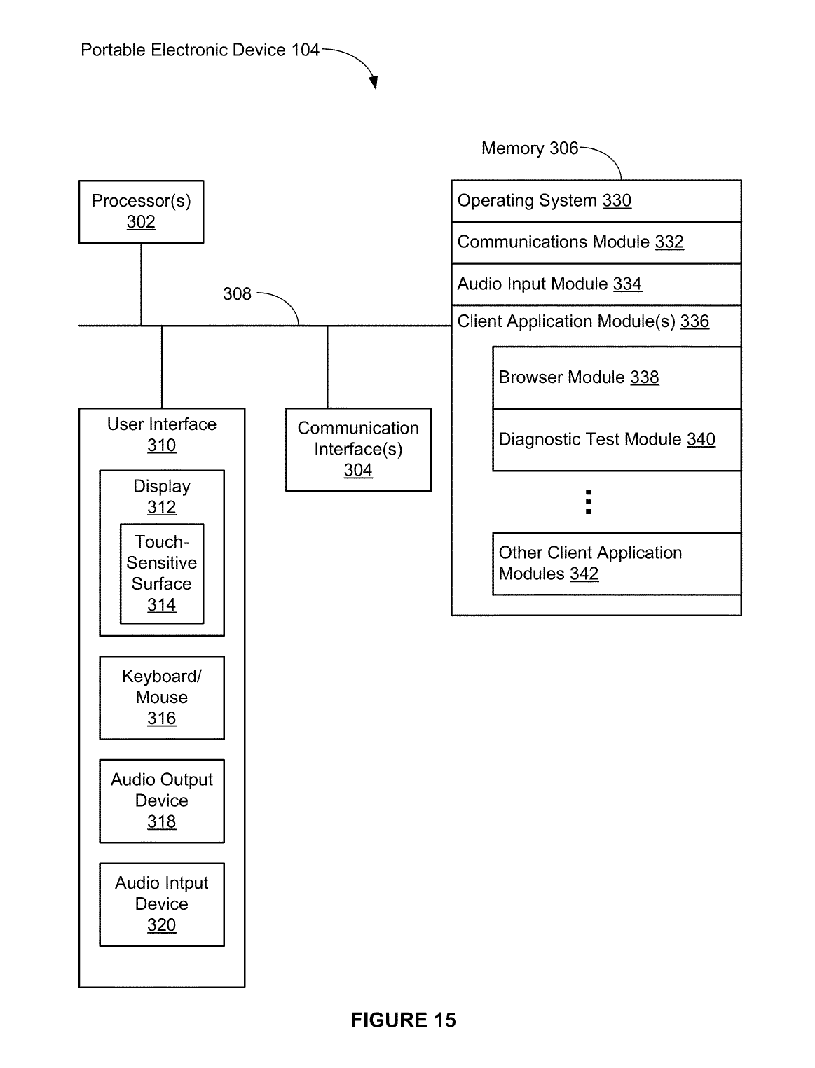

FIG. 15 is a block diagram illustrating an exemplary portable electronic device in accordance with some embodiments. The electronic device 104 typically includes one or more processing units (processors or cores) 302, one or more network or other communications interfaces 304, memory 306, and one or more communication buses 308 for interconnecting these components. The communication buses 308 optionally include circuitry (sometimes called a chipset) that interconnects and controls communications between system components. The electronic device 104 includes a user interface 310. The user interface 310 typically includes a display device 312. In some embodiments, the electronic device 104 includes inputs such as a keyboard, mouse, and/or other input buttons 316. Alternatively or in addition, in some embodiments, the display device 312 includes a touch-sensitive surface 314, in which case the display device 312 is a touch-sensitive display. The user interface 310 also includes an audio output device 318, such as speakers or an audio output connection connected to speakers, earphones, or headphones. Furthermore, some electronic devices 104 use a microphone and voice recognition to supplement or replace the keyboard. Optionally, the electronic device 104 includes an audio input device 320 (e.g., a microphone) to capture audio (e.g., speech from a user).

Memory 306 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 306 may optionally include one or more storage devices remotely located from the processor(s) 302. Memory 306, or alternately the non-volatile memory device(s) within memory 306, includes a non-transitory computer readable storage medium. In some embodiments, memory 306 or the computer readable storage medium of memory 306 stores the following programs, modules and data structures, or a subset or superset thereof:
an operating system 330 that includes procedures for handling various basic system services and for performing hardware dependent tasks;
a network communication module 332 that is used for connecting the electronic device 104 to other computers via the one or more communication network interfaces 304 (wired or wireless) and one or more communication networks, such as the Internet, cellular telephone networks, mobile data networks, other wide area networks, local area networks, metropolitan area networks, and so on;
an audio input module 334 (e.g., a microphone module) for processing audio captured by the audio input device 320, where the respective audio may be sent or streamed (e.g., by a client application module) to the server system 108; and
one or more client application modules 336, including the following modules (or sets of instructions), or a subset or superset thereof:
   a web browser module 338 (e.g., Internet Explorer by Microsoft, Firefox by Mozilla, Safari by Apple, or Chrome by Google) for accessing, viewing, and interacting with web sites,
   a diagnostic test module 340 for sending forms to a server system and receiving data from the server system; and/or
   other optional client application modules 342, such as applications for word processing, calendaring, mapping, weather, stocks, time keeping, virtual digital assistant, presenting, number crunching (spreadsheets), drawing, instant messaging, e-mail, telephony, video conferencing, photo management, video management, a digital music player, a digital video player, 2D gaming, 3D (e.g., virtual reality) gaming, electronic book reader, and/or workout support.

Each of the above identified modules and applications correspond to a set of executable instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules are, optionally, combined or otherwise re-arranged in various embodiments. In some embodiments, memory 306 stores a subset of the modules and data structures identified above. Furthermore, memory 306 optionally stores additional modules and data structures not described above.

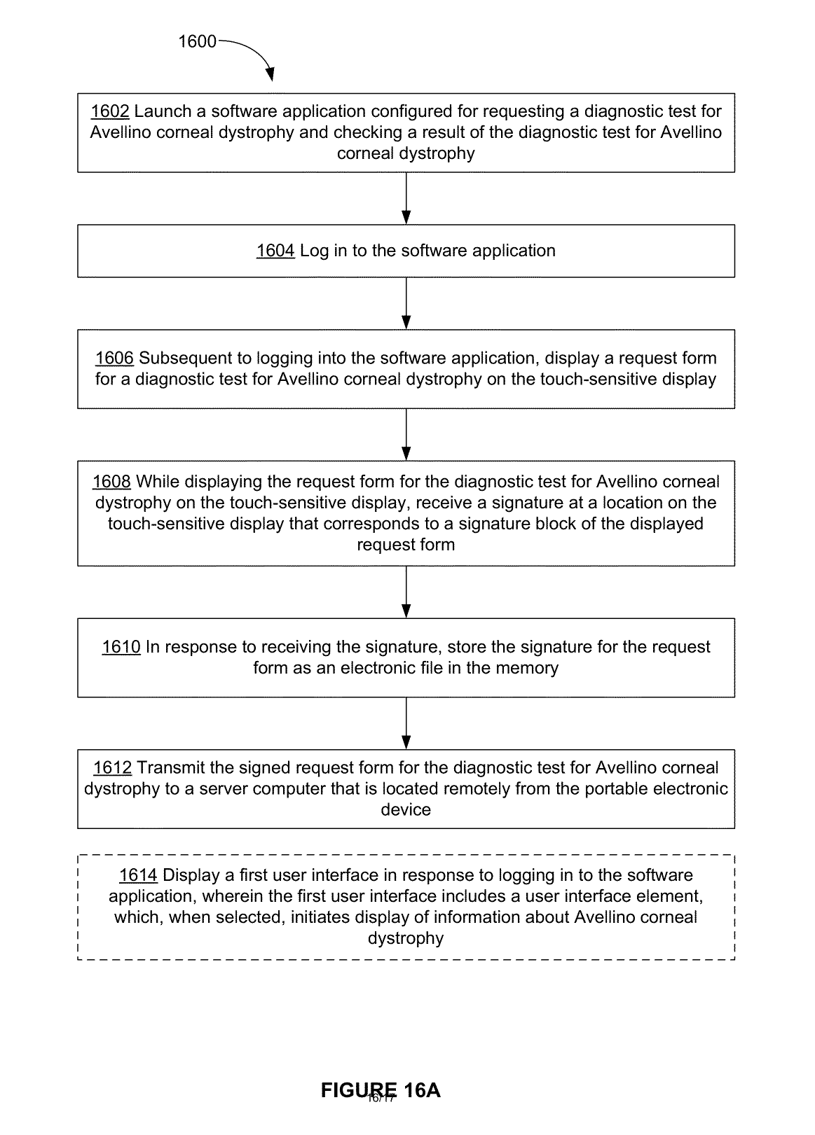

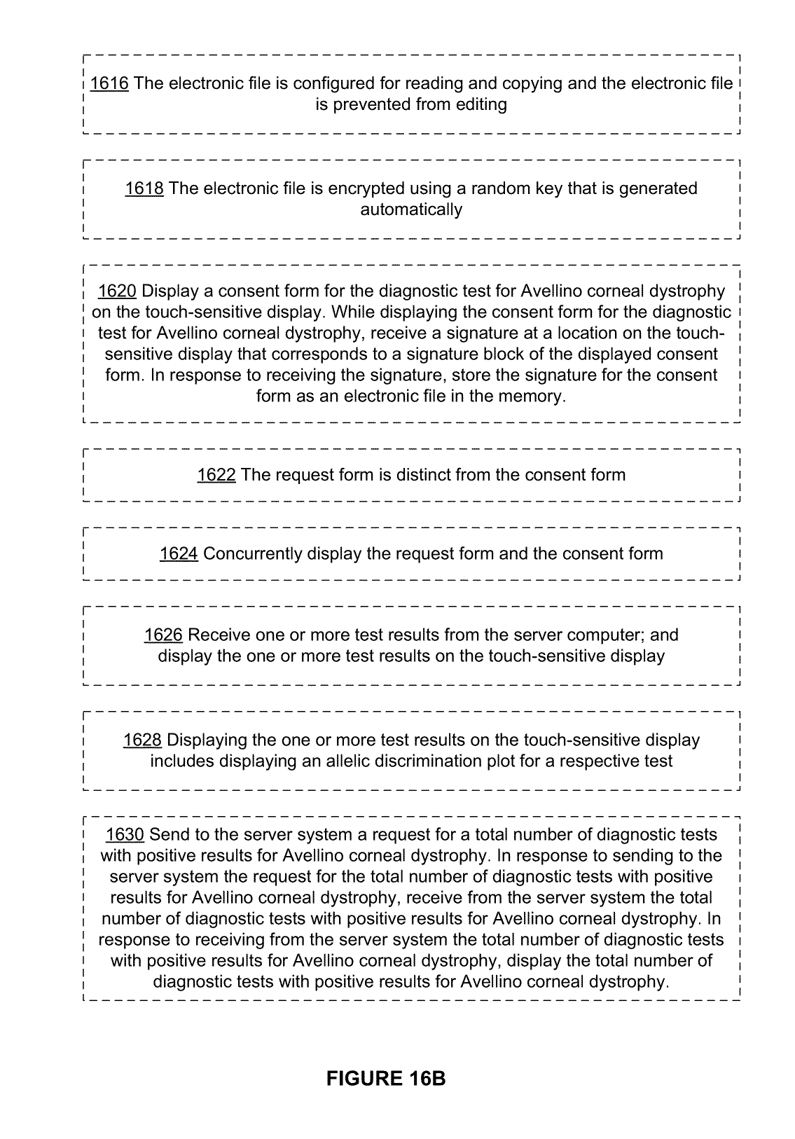

FIGS. 16A-16B are flow diagrams illustrating a method 1600 of requesting a diagnostic test for Avellino corneal dystrophy in accordance with some embodiments.

In some embodiments, the method 1600 is performed at a portable electronic device (e.g., the electronic device 104) that includes one or more processors, memory, and a touch-sensitive display.

The device launches (1602) a software application configured for requesting a diagnostic test for Avellino corneal dystrophy and checking a result of the diagnostic test for Avellino corneal dystrophy.

The device logs (1604) in to the software application.

Subsequent to logging into the software application, the device displays (1606) a request form for a diagnostic test for Avellino corneal dystrophy on the touch-sensitive display.

While displaying the request form for the diagnostic test for Avellino corneal dystrophy on the touch-sensitive display, the device receives (1608) a signature at a location on the touch-sensitive display that corresponds to a signature block of the displayed request form.

In response to receiving the signature, the device stores (1610) the signature for the request form as an electronic file in the memory. In some embodiments, the device converts the signed request form into an electronic file and stores the electronic file in the memory.

The device transmits (1612) the signed request form for the diagnostic test for Avellino corneal dystrophy to a server computer that is located remotely from the portable electronic device.

In some embodiments, the device displays (1614) a first user interface in response to logging in to the software application. The first user interface includes a user interface element, which, when selected, initiates display of information about Avellino corneal dystrophy.

In some embodiments, the electronic file is configured (1616, FIG. 16B) for reading and copying and the electronic file is prevented from editing.

In some embodiments, the electronic file is encrypted (1618) using a random key that is generated automatically.

In some embodiments, the device displays (1620) a consent form for the diagnostic test for Avellino corneal dystrophy on the touch-sensitive display. While displaying the consent form for the diagnostic test for Avellino corneal dystrophy, the device receives a signature at a location on the touch-sensitive display that corresponds to a signature block of the displayed consent form. In response to receiving the signature, the device stores the signature for the consent form as an electronic file in the memory.

In some embodiments, the request form is distinct (1622) from the consent form.

In some embodiments, the device concurrently displays (1624) the request form and the consent form.

In some embodiments, the device receives (1626) one or more test results from the server computer; and displays the one or more test results on the touch-sensitive display.

In some embodiments, displaying the one or more test results on the touch-sensitive display includes (1628) displaying an allelic discrimination plot for a respective test.

In some embodiments, the device sends (1630) to the server system a request for a total number of diagnostic tests with positive results for Avellino corneal dystrophy. In response to sending to the server system the request for the total number of diagnostic tests with positive results for Avellino corneal dystrophy, the device receives from the server system the total number of diagnostic tests with positive results for Avellino corneal dystrophy. In response to receiving from the server system the total number of diagnostic tests with positive results for Avellino corneal dystrophy, the device displays the total number of diagnostic tests with positive results for Avellino corneal dystrophy.

The above describes in detail particular embodiments. These specific embodiments are merely illustrative embodiments to facilitate the understanding of the principles described herein, and are not intended to limit the scope of the claims. A person having ordinary skill in the art would understand that the underlying principles can be practiced without some of the features described herein. A person having ordinary skill in the art would also understand that the underlying principles can be practiced with additional features not described herein (which are omitted so as not to obscure certain aspects of the principles described herein). Therefore, the claims are intended to cover their equivalent.

By utilizing methods and systems described herein, users can request diagnostic tests for Avellino corneal dystrophy and check results of such tests anytime, anywhere, at users' convenience.

What is claimed is:

1. A method, comprising:
at a portable electronic device that includes one or more processors, memory, and a touch-sensitive display:
launching a software application configured for requesting a diagnostic test for Avellino corneal dystrophy and checking a result of the diagnostic test for Avellino corneal dystrophy;
logging in to the software application;
subsequent to logging into the software application, displaying a request form for a diagnostic test for Avellino corneal dystrophy on the touch-sensitive display;
while displaying the request form for the diagnostic test for Avellino corneal dystrophy on the touch-sensitive display, receiving a signature at a location on the touch-sensitive display that corresponds to a signature block of the displayed request form;
in response to receiving the signature, storing the signature for the request form as an electronic file in the memory; and
transmitting the signed request form for the diagnostic test for Avellino corneal dystrophy to a server computer that is located remotely from the portable electronic device.

2. The method of claim 1, including:
displaying a first user interface in response to logging in to the software application, wherein the first user interface includes a user interface element, which, when selected, initiates display of information about Avellino corneal dystrophy.

3. The method of claim 1, wherein the electronic file is configured for reading and copying and the electronic file is prevented from editing.

4. The method of claim 3, wherein the electronic file is encrypted using a random key that is generated automatically.

5. The method of claim 1, including:
displaying a consent form for the diagnostic test for Avellino corneal dystrophy on the touch-sensitive display;
while displaying the consent form for the diagnostic test for Avellino corneal dystrophy, receiving a signature at a location on the touch-sensitive display that corresponds to a signature block of the displayed consent form; and
in response to receiving the signature, storing the signature for the consent form as an electronic file in the memory.

6. The method of claim 5, wherein the request form is distinct from the consent form.

7. The method of claim 6, including:
concurrently displaying the request form and the consent form.

8. The method of claim 1, including:
receiving one or more test results from the server computer; and
displaying the one or more test results on the touch-sensitive display.

9. The method of claim 1, wherein displaying the one or more test results on the touch-sensitive display includes displaying an allelic discrimination plot for a respective test.

10. The method of claim 1, including:
sending to the server system a request for a total number of diagnostic tests with positive results for Avellino corneal dystrophy;
in response to sending to the server system the request for the total number of diagnostic tests with positive results for Avellino corneal dystrophy, receiving from the server system the total number of diagnostic tests with positive results for Avellino corneal dystrophy;
in response to receiving from the server system the total number of diagnostic tests with positive results for Avellino corneal dystrophy, displaying the total number of diagnostic tests with positive results for Avellino corneal dystrophy.

11. A portable electronic device, comprising:
one or more processors,
a touch-sensitive display, and
memory storing one or more programs for execution by the one or more processors, the one or more programs, when executed by the one or more processors, causing the portable electronic device to perform a method comprising:
launching a software application configured for requesting a diagnostic test for Avellino corneal dystrophy and checking a result of the diagnostic test for Avellino corneal dystrophy;
logging in to the software application;
subsequent to logging into the software application, displaying a request form for a diagnostic test for Avellino corneal dystrophy on the touch-sensitive display;
while displaying the request form for the diagnostic test for Avellino corneal dystrophy on the touch-sensitive display, receiving a signature at a location on the touch-sensitive display that corresponds to a signature block of the displayed request form;
in response to receiving the signature, storing the signature for the request form as an electronic file in the memory; and
transmitting the signed request form for the diagnostic test for Avellino corneal dystrophy to a server computer that is located remotely from the portable electronic device.

12. A non-transitory computer readable storage medium, storing:
one or more programs for execution by a portable electronic device with a touch-sensitive display, the one or more programs, when executed by the portable electronic device, causing the portable electronic device to perform a method comprising:
launching a software application configured for requesting a diagnostic test for Avellino corneal dystrophy and checking a result of the diagnostic test for Avellino corneal dystrophy;
logging in to the software application;
subsequent to logging into the software application, displaying a request form for a diagnostic test for Avellino corneal dystrophy on the touch-sensitive display;
while displaying the request form for the diagnostic test for Avellino corneal dystrophy on the touch-sensitive display, receiving a signature at a location on the touch-sensitive display that corresponds to a signature block of the displayed request form;
in response to receiving the signature, storing the signature for the request form as an electronic file in the memory; and
transmitting the signed request form for the diagnostic test for Avellino corneal dystrophy to a server computer that is located remotely from the portable electronic device.
